(19) United States
(12) Patent Application Publication
(10) Pub. No.: US 2026/0310694 A1
(43) Pub. Date: Oct. 8, 2026

(54) GENERATING CONTENT WITH GENERATIVE ARTIFICIAL INTELLIGENCE (AI) MODELS BY PARALLEL DECODING USING DISAGGREGATED DISTRIBUTIONS

(71) Applicant: Microsoft Technology Licensing, LLC, Redmond, WA (US)

(72) Inventors: Pinkesh BADJATIYA, Madhya Pradesh (IN); Rajendra Bhimsen SHINDE, Telangana (IN)

(21) Appl. No.: 19/212,395

(22) Filed: May 19, 2025

(30) Foreign Application Priority Data
Apr. 4, 2025 (IN) 202511033453

(51) Int. Cl. G06F 16/3329; G06F 16/335

(52) U.S. Cl. CPC G06F 16/33295; G06F 16/335

(57) ABSTRACT

This disclosure describes utilizing a suggestion item system to quickly, accurately, and efficiently generate suggestion items using generative artificial intelligence (AI) models and multiple embedding groups. For example, in response to detecting user input, which is often associated with search queries, the suggestion item system provides the user input to multiple generative AI models or model instances that utilize parallel decoding and distinct embedding groups to generate suggestion items. By using parallel decoding from separate embedding groups, the suggestion item system can quickly provide high-quality, accurate, and unique suggestion items in response to user inputs.

### CROSS-REFERENCE TO RELATED APPLICATIONS

This application claims benefit and priority to Indian Provisional Application Number 202511033453, filed on Apr. 4, 2025, the entirety of which is incorporated herein by reference.

### BACKGROUND

In recent years, there have been significant advancements in both hardware and software domains, specifically in the field of internet search and obtaining instant answers. Current query response systems are designed to quickly retrieve and present resources and answers in response to user questions and queries. However, many query response systems suffer from high latency time and processing costs when providing responses. These and other challenges are prevalent in many current query response systems, as further described below.

### BRIEF DESCRIPTION OF THE DRAWINGS

The following detailed description provides specific implementations accompanied by drawings. Additionally, each of the figures listed below corresponds to one or more implementations discussed in this disclosure.

FIG. 1 illustrates an example overview of a suggestion item system using generative artificial intelligence (AI) models and multiple embedding groups to perform parallel decoding to generate suggestion items based on user input.

FIG. 2 illustrates an example computing environment where the suggestion item system is implemented.

FIG. 3 illustrates an example diagram for generating training data subsets from a training dataset for generating related disaggregated embedding groups.

FIGS. 4A-4B illustrate example diagrams for creating disaggregated embedding groups using generative AI models.

FIG. 5 illustrates an example diagram chart showing distributions of multiple embedding groups generated from a common training dataset.

FIG. 6 illustrates an example diagram for generating suggestion items based on user input with generative AI models using parallel decoding from different embedding groups.

FIGS. 7A-7B illustrate example graphical user interfaces for showing suggestion items provided in response to user input.

FIG. 8 illustrates an example series of acts of a computer-implemented method for generating suggestion items using one or more AI models.

FIG. 9 illustrates example components included within a computer system used to implement the suggestion item system.

### DETAILED DESCRIPTION

This disclosure describes utilizing a suggestion item system to quickly, accurately, and efficiently generate suggestion items using generative artificial intelligence (AI) models and multiple distribution embedding groups. For example, in response to detecting user input, which is often associated with search queries, the suggestion item system provides the user input to multiple generative AI models or model instances that utilize parallel decoding and separate embedding groups to generate suggestion items. By using parallel decoding from separate embedding groups, the suggestion item system can quickly provide high-quality, accurate, and distinct suggestion items in response to user inputs.

Implementations of the present disclosure provide benefits and solve problems in the field with systems, computer-readable media, and computer-implemented methods that utilize the suggestion item system to provide distinct suggestion items quickly and accurately in response to user inputs. As described below, in some instances, the suggestion item system generates an aggregated distribution embedding space that includes multiple embedding groups and then utilizes the aggregated distribution embedding space with multiple generative AI models in parallel to generate distinct suggestion items for detected user input. In some instances, the suggestion item system generates and utilizes the multiple embedding groups (without generating an aggregated distribution embedding space) with the multiple generative AI models in parallel to generate the distinct suggestion items for detected user input.

To illustrate, in various implementations, the suggestion item system generates suggestion items using one or more generative AI models in response to receiving user input associated with a search query. To elaborate, upon receiving the user input, the suggestion item system generates multiple suggestion item prompts that include the user input and multiple different embedding group identifiers. In addition, the suggestion item system provides the multiple suggestion item prompts in parallel to a corresponding number of generative AI models, which use the different embedding groups to generate separate and often semantically diverse suggestion items corresponding to the user input. Upon receiving the suggestion items from the generative AI models, the suggestion item system can also provide the suggestion items in response to receiving the user input, sometimes as a list of suggestions.

As mentioned above, many existing systems struggle to provide both quick and accurate supplemental content to users performing searches. Examples of supplemental content include autocomplete suggestions, related searches, follow-on queries, and other suggested content based on a user query or partial user input. High-quality supplemental content should be both relevant to the context of the user input and aligned with a user’s search intent. As noted, some systems utilize generative AI models to provide supplemental content; however, generative AI models are complex and can take long time periods to generate supplemental content, especially as the volume of supplemental content being provided increases.

To elaborate, many generative AI models, such as large language models (LLMs), utilize autoregressive inference to generate a sequence of plausible next tokens (e.g., words in a sentence) for a given prefix (e.g., user input). The generation of each subsequent token depends on the prefix provided and the previously generated tokens. Various decoding algorithms, including greedy decoding, top-k sampling, beam search, and nucleus sampling, offer different strategies for obtaining these generations during autoregressive inference. However, when faced with the task of generating a set of separate suggestion items (e.g., a list of suggestions), some of these algorithms prove inadequate.

For generative AI models using decoding algorithms that can generate a set of separate suggestion items, these models largely decode suggestion items serially. To illustrate, based on a model prefix (e.g., user input), the model decodes a first suggestion item. For the second suggestion item, the model uses the user input and the first suggestion item to generate a second, distinct suggestion item. For the third suggestion item, the model uses the user input, the first suggestion item, and the second suggestion item to decode a third, distinct suggestion item. For each subsequent item, the model considers all previously decoded items. This increases the processing complexity (e.g., required power and resources) and time for each additional suggestion item decoded. The high latency costs (e.g., time delay) alone make using generative AI models, even small language models (SLMs), infeasible for providing more than a few suggestion items for a search query.

To reduce processing time, existing systems have attempted to use multiple modes in parallel. For example, some systems utilize multiple instances of the same generative AI model (e.g., using the same decoding algorithm) simultaneously. However, these models often provide the same or similar suggestion items. Some systems utilize multiple instances of different generative AI models (e.g., using different decoding algorithms) at the same time. Again, these models produce many semantically duplicate items (e.g., the results are the same or closely overlapping because the different models use similar embedding spaces to generate their responses), which is inadequate for a list of suggestion items.

In contrast to existing systems, the suggestion item system provides semantically distinct, accurate, and high-quality suggestion items with low latency. Indeed, as described in this document, the suggestion item system delivers several significant technical benefits in terms of computing efficiency, accuracy, and flexibility compared to existing systems. Moreover, the suggestion item system provides several practical applications that address problems by presenting a framework that generates sets of high-quality suggestion items with reduced processing requirements and low latency.

To elaborate, in various implementations, the suggestion item system improves computing efficiency through capacity optimization. By using multiple generative AI models in parallel to each generate a single suggestion item, the suggestion item system reduces the computational cost used by a single generative AI model generating the same total number of suggestion items. As described above, a single generative AI model increases computational costs significantly with each additional decoded item. Thus, as the number of generated suggestion items increases, the suggestion item system provides ever-increasing computational cost savings.

Furthermore, parallel processing also provides batch resource gain. For instance, if multiple generative AI models (or instances of the same model) are decoding resources around the same time, the models can make a single collective call to computing resources, such as attention cache calls or memory access calls, and use the retrieved data across all of the generative AI models. In contrast, a single model performing sequential decoding makes these calls at each interaction. Indeed, the suggestion item system reduces computing processing during inference multi-fold.

In one or more implementations, the suggestion item system improves computing efficiency through significantly reduced latency during inference. Indeed, researchers recorded an average latency savings of 25% compared to sequential decoding systems with no drop in quality. To elaborate, as apparent from the above discussion, the suggestion item system uses parallel decoding across multiple generative AI models and distinct embedding groups to generate different suggestion items in a single pass or shot. In contrast, existing systems that use sequential model decoding require multiple passes, with each pass taking longer than the previous pass. In various implementations, these latency savings are achieved by transferring the complexity of generating diverse suggestion items to the training stage, which is performed once, whereas inference occurs repeatedly.

In various implementations, the suggestion item system provides improved computational flexibility. For example, by using different training datasets, the suggestion item system can generate different embedding groups that correspond to different use cases. Furthermore, the different embedding groups can be used with different model types, versions, and decoding algorithms and still yield high-quality results with reduced latency. By doing so, the suggestion item system allows for the suggestion items to be provided across a wide range of applications and services. The suggestion item system has the additional benefit of improving user experience and engagement by providing fast, high-quality suggestion items (e.g., autocomplete suggestions, follow-on queries, and other generated content).

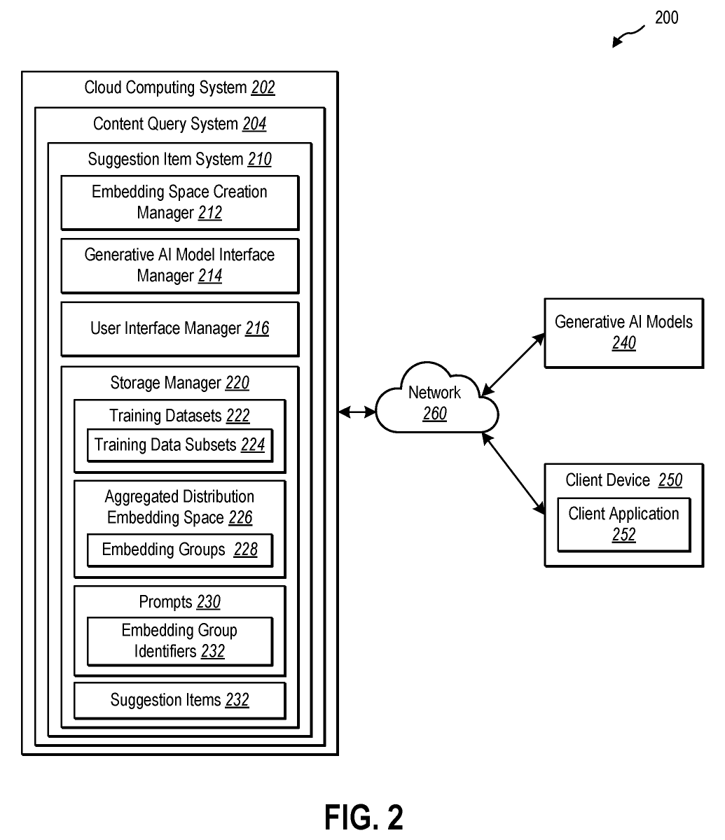

As illustrated in the preceding discussion, this disclosure uses a variety of terms to describe the features and advantages of one or more described implementations. For instance, this disclosure describes the suggestion item system within the context of a cloud computing system. As an example, the term “cloud computing system” refers to a network of interconnected computing devices that provide various services and applications to computing devices (e.g., server devices and client devices) inside or outside the cloud computing system. An example of a cloud computing system is described below in connection with FIG. 2.

As an example, a “generative artificial intelligence (AI) model” is an artificial intelligence system that utilizes deep learning and a large number of parameters (e.g., in the billions or trillions), which are trained and/or fine-tuned on one or more extensive datasets to produce coherent, contextually relevant, and fluently topic-specific outputs (e.g., text and/or images). In many instances, a generative model refers to an advanced computational system that uses natural language processing, machine learning, and/or image processing to generate coherent and contextually relevant human-like responses.

Generative AI models (both large and small) have applications in natural language understanding, content generation, text summarization, dialogue systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats, ranging from comprehensive generative summaries, generative visual digests of several types to direct answer generative documents.

Moreover, generative AI models are primarily based on transformer architectures for understanding, generating, and manipulating human language. Generative AI models can also utilize other types of architectures, such as recurrent neural networks (RNNs), long short-term memory (LSTM) models, convolutional neural networks (CNNs), or other architectures. Examples of generative AI models include generative pre-trained transformer (GPT) models like GPT-3.5, GPT-4, and GPT-4o, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large generative AI model (LGM), a small generative AI model (SGM), a large language model (LLM), a small language model (SLM), and a small action model (SAM), which serve as text-based versions of generative AI models that receive text prompts and/or generate text outputs. In various implementations, a generative AI model is a multimodal generative model that receives multiple input formats (e.g., text, images, video, and data structures) and/or generates multiple output formats.

As mentioned above, generative AI models include small generative AI models, such as small language models (SLMs). As an example, a “small generative AI model” refers to a smaller version or specialized version of an artificial intelligence system that utilizes significantly fewer parameters than large generative AI models. For example, a small generative AI model uses 1.5 billion parameters (as opposed to the 7 billion parameters of a large generative AI model). Additionally, in contrast to large models that perform tasks generally, a small generative AI model is fine-tuned to perform specific or specialized tasks. For instance, different small generative AI models can be fine-tuned to perform varying operations to create a generative document, as described below. In some instances, a small generative AI model performs a broad range of applications but lacks the stored memory or internal data recall abilities of large generative AI models.

As an example, the terms “prompt,” “model prompt,” or “generative AI model prompt” refer to a request made to a generative AI model to create a generative AI model output based on plain language guidance. In some instances, the suggestion item system provides additional information along with a prompt. A prompt can include important contextual information and/or general framing information to ensure that the generative AI model understands the correct context, syntax, and grounding information of the data it is processing. Examples of prompts, such as suggestion item prompts, are provided below.

As an example, the terms “combined distribution embedding space” and “aggregated distribution embedding space” refers to a multidimensional space where multiple distributions of data points are combined or aggregated. A combined distribution embedding space may include multiple data point distributions in a single embedding space. A combined distribution embedding space can include multiple embedding groups, where each embedding group has a unique embedding space distribution (e.g., a set of data points with specific statistical properties). In some implementations, a combined distribution embedding space refers to multiple related embedding groups stored or maintained together, but not combined into a single embedding space.

As another example, the terms “embedding space group” and “embedding group” refer to a collection of data points within an embedding space that share similar characteristics or distributions. When multiple embedding groups, each with distinct distributions, are combined, they form the aggregated distribution embedding space. Likewise, when multiple generative AI models access an aggregated distribution embedding space, each model can isolate a different embedding group (e.g., disaggregate the embedding groups) to generate semantically different suggestion items. Additionally, multiple embedding groups can be generated from a dataset that has been separated into data subsets, as further described below. Embedding groups can be identified by a unique or separate identifier (e.g., an embedding space group identifier or an embedding group identifier) or token (e.g., an embedding group token or an embedding space token). In various instances, embedding groups are stored or maintained independently and identified by a generative AI model based on an embedding group identifier.

As an example, the term “user input” refers to text or other forms of input received from a user. User input is mainly provided for a search query system or content query system to use to identify and return a search query response. Indeed, user input is often associated with a search query. In some implementations, user input refers to a search query. In some instances, user input refers to a portion of a search query that is or can be provided as a search query. While user input is often received within a text input field, it may include captured audio or images as well.

As an example, the term “suggestion items” refers to generative content provided in response to user input. A suggestion item often includes content generated by a generative AI model for providing a suggested search query to a user. Suggestion items may be presented to a user as individual items or part of a set (e.g., a list of suggestions). Examples of suggestion items include autocomplete phrases, follow-on queries, related questions, location-based suggestion queries, recommendation questions, creative prompts, and other query-related suggestions.

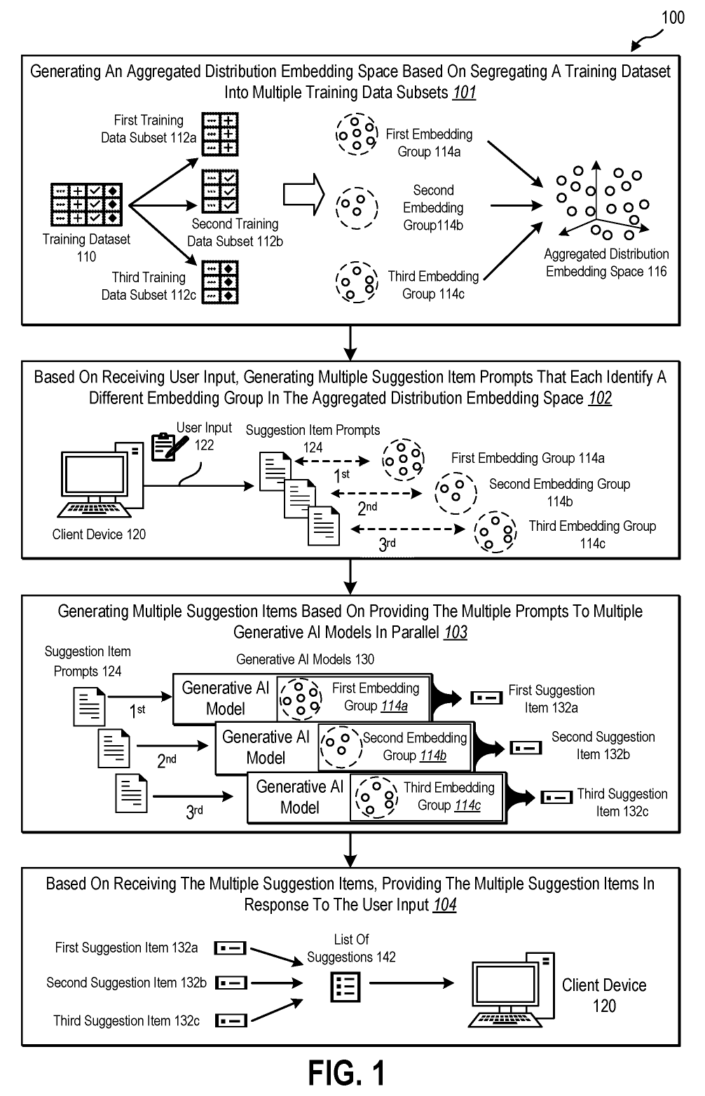

Implementation examples and details of the suggestion item system are discussed in connection with the accompanying figures, which are described next. For example, FIG. 1 illustrates an example overview of a suggestion item system using generative AI models and multiple embedding groups to perform parallel decoding to generate suggestion items based on user input according to some implementations. While FIG. 1 provides a high-level overview of the invention, additional details are provided in subsequent figures.

FIG. 1 illustrates a series of acts 100 performed by or following directions from the suggestion item system (e.g., a user query generative suggestion item system). As shown, the series of acts 100 briefly illustrates how the suggestion item system uses generative artificial intelligence (AI) models to create multiple relevant suggestion items with generative AI models that utilize parallel decoding (e.g., parallel disaggregated distribution sampling) and multiple embedding groups, with reduced latency compared to systems that use sequential decoding on a single generative AI model.

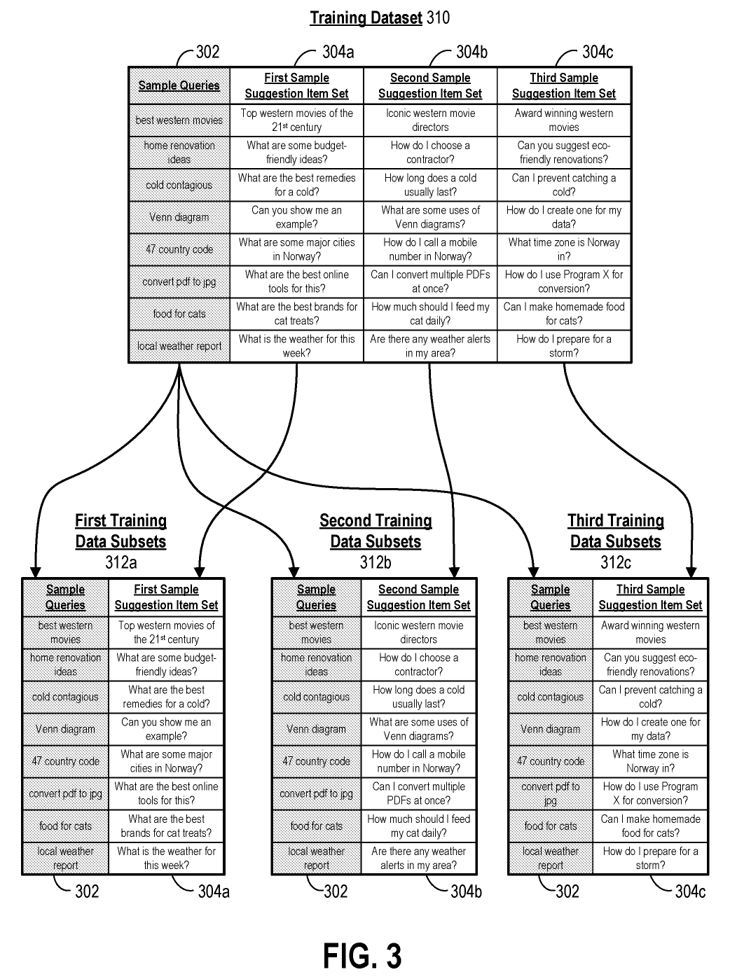

As shown, the series of acts 100 includes act 101 of generating an aggregated distribution embedding space based on segregating a training dataset into multiple training data subsets. For example, the suggestion item system obtains a training dataset 110 and divides it into multiple training data subsets (e.g., a first training data subset 112a, a second training data subset 112b, and a third training data subset 112c). Additionally, the suggestion item system uses the training data subsets to generate multiple embedding groups (e.g., a first embedding group 114a, a second embedding group 114b, and a third embedding group 114c) with distinct embedding distributions, which combine to form the aggregated distribution embedding space 116. While a single embedding space is shown for the aggregated distribution embedding space 116, in various instances, the aggregated distribution embedding space 116 represents a collection of embedding groups maintained together but not combined into a single embedding space. Additional details regarding generating an aggregated distribution embedding space with multiple embedding groups are provided below in connection with FIGS. 3, 4A-4B, and 5.

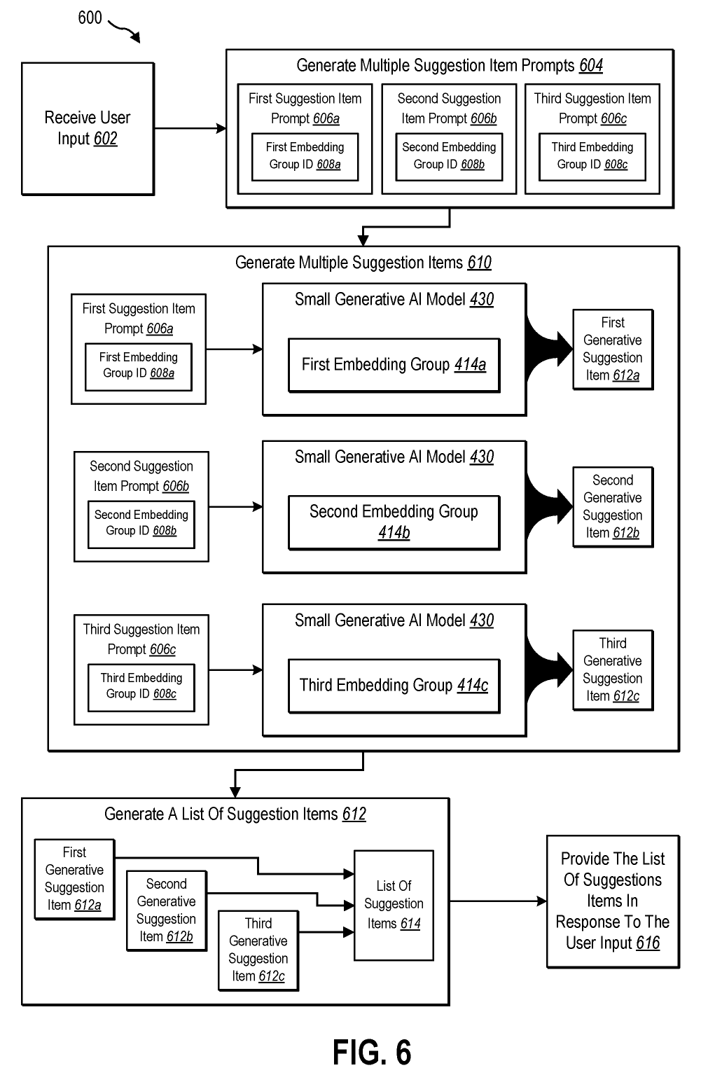

As described in this document, the suggestion item system can provide suggestion items in response to user input. To elaborate, based on receiving user input, act 102 includes generating multiple suggestion item prompts that each identify a different embedding group in the aggregated distribution embedding space. For example, a client device 120 provides user input 122 related to a search query, and in response, the suggestion item system generates suggestion item prompts 124. Each suggestion item prompt includes a separate embedding group identifier that indicates a target embedding group within the aggregated distribution embedding space 116. Additional details regarding generating suggestion item prompts based on user input are provided below in connection with FIG. 6.

Act 103 includes generating multiple suggestion items based on providing the multiple prompts to multiple generative AI models in parallel. In various implementations, the suggestion item system provides the suggestion item prompts 124, the user input 122, and the embedding group identifier to generative AI models 130. For example, the suggestion item system provides each suggestion item prompt to a separate generative AI model to be processed based on parallel decoding. Based on the embedding group indicated in each suggestion item prompt, the corresponding generative AI model processes the user input according to a distinct embedding group, which causes each model to generate a separate suggestion item (e.g., a first suggestion item 132a, a second suggestion item 132b, and a third suggestion item 132c). Additional details regarding generating suggestion item prompts using generative AI models with parallel decoding are provided below in connection with FIG. 6.

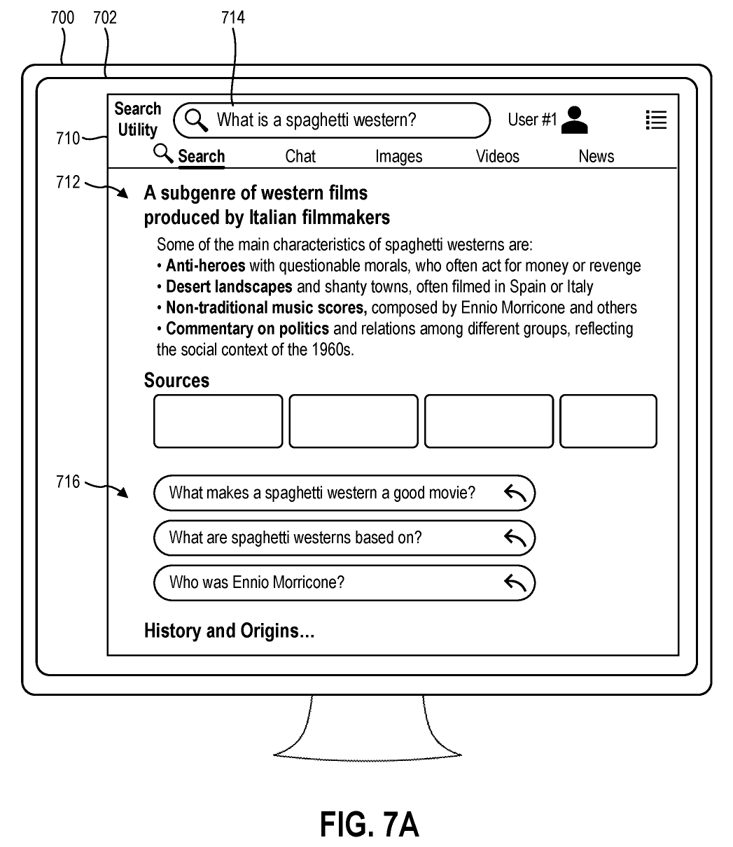

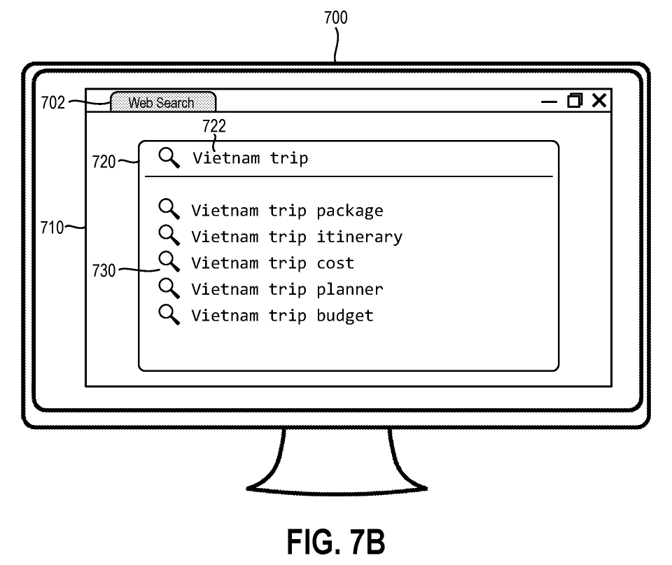

Act 104 includes, based on receiving the multiple suggestion items, providing the multiple suggestion items in response to the user input. For instance, upon the generative AI models 130 generating and returning the suggestion items, the suggestion item system provides the suggestion items to the client device 120. In some instances, the suggestion item system compiles the suggestion items from the multiple generative AI models into a list of suggestions 142. In some implementations, the suggestion item system provides the suggestion items or the list of suggestions 142 to the client device 120 in connection with providing search query results. Examples of providing suggestion items to a client device are provided below in connection with FIGS. 7A-7B.

With a general overview in place, additional details are provided regarding the components, features, and elements of the suggestion item system. To illustrate, FIG. 2 shows an example computing environment where the suggestion item system is implemented according to some implementations. In particular, FIG. 2 illustrates an example of a computing environment 200 with various computing devices, including a cloud computing system 202 associated with a suggestion item system 210. While FIG. 2 shows example arrangements and configurations of the computing environment 200, the cloud computing system 202, the suggestion item system 210, and associated components, other arrangements and configurations are possible.

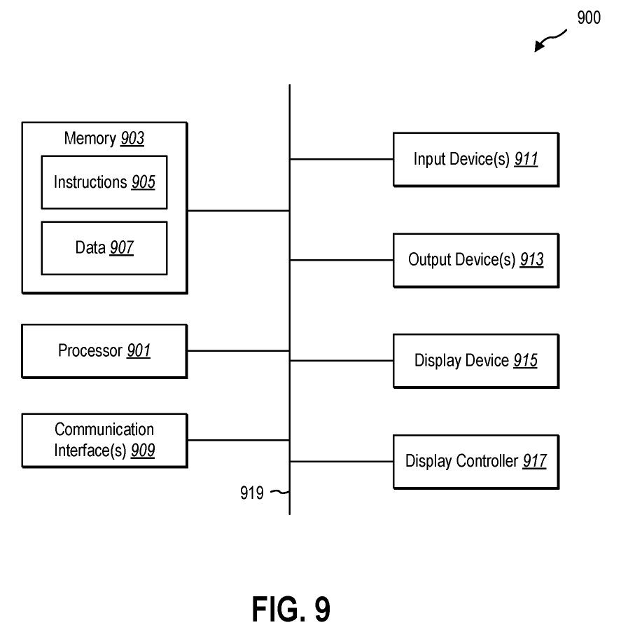

As shown, the computing environment 200 includes a cloud computing system 202 associated with the suggestion item system 210, generative AI models 240, and a client device 250 with a client application 252, connected via a network 260. Many of these components may be implemented on one or more computing devices, such as one or more server devices, while some of these components may be implemented on personal devices. Further details regarding computing devices are provided below in connection with FIG. 9, along with additional details regarding networks, such as the network 260 shown.

Before describing the components of the cloud computing system 202, including the suggestion item system 210, other components of the computing environment 200 are discussed first to provide better context for the suggestion item system 210. As shown, the computing environment 200 includes the generative AI models 240, which correspond to one or more generative models tuned to efficiently perform various operations.

The generative AI models 240 can include small generative AI models (SGMs), including small language models (SLMs). For instance, an SLM is fine-tuned to perform particular tasks, such as token decoding to generate suggestion items. In one or more implementations, the generative AI models 240 include large generative models (LGMs), such as a large language model (LLM). In various instances, a large generative AI model performs a broader range of tasks. Additionally, in some implementations, the small or large generative AI models are text-based generative AI models or text-only generative models that output text data (e.g., no images or audio), which operate more efficiently and quickly than multimodal-based models.

As shown, the computing environment 200 includes the client device 250. In various implementations, the client device 250 is associated with a user (e.g., a user client device) who requests a search query. In various instances, the client device 250 includes a client application 252, such as a web browser, mobile application, or another form of computer application for accessing and/or interacting with the cloud computing system 202 and/or the suggestion item system 210. For example, the client device 250 utilizes the client application 252 to provide user input, which the suggestion item system 210 receives. In response, the suggestion item system 210 provides suggestion items to the client application 252, often along with search query results.

Returning to the cloud computing system 202, as shown, the cloud computing system 202 includes a context query system 204 (e.g., a search query system or generative chat system) and the suggestion item system 210. In various implementations, the context query system 204 provides search results in response to a search query. For example, the client device 250 submits a search request (or begins to submit a search query by providing user input), and the context query system 204 returns search results.

As shown, the suggestion item system 210 includes various components and elements implemented in hardware and/or software. For example, the suggestion item system 210 includes an embedding space creation manager 212, a generative AI model interface manager 214, a user interface manager 216, and a storage manager 220. The storage manager 220 includes training datasets 222 and training data subsets 224, an aggregated distribution embedding space 226 with embedding groups 228, prompts 230, and suggestion items 232.

As mentioned, the suggestion item system 210 includes the embedding space creation manager 212, which facilitates generating training data subsets 224 from the training datasets 222. In addition, the embedding space creation manager 212 can generate embedding groups 228 from the training datasets 222 to create an embedding space 226. In various implementations, the embedding space creation manager 212 utilizes one or more of the generative AI models 240 to create the embedding groups 228 and the embedding space 226 via training.

The suggestion item system 210 includes the generative AI model interface manager 214, which utilizes the embedding space 226 and the embedding groups 228 to generate suggestion items 232 from the generative AI models 240. For example, the generative AI model interface manager 214 creates generative AI models 240 (e.g., suggestion item prompts) that include embedding group identifiers indicating different embedding groups for the generative AI models 240 to use to generate separate, but related, suggestion items 232.

In some implementations, the user interface manager 216 implements the delivery of the suggestion items 232 to client devices (e.g., the client device 250) in connection with submitting a search query or providing search results for a search query. For example, the user interface manager 216 works with the suggestion item system 210 to provide the suggestion items 232 (or a list of suggestions) and facilitate user selection of one of the suggestion items 232 to perform additional content searches.

In some implementations, the suggestion item system 210 is located on a separate computing device from the context query system 204 within the cloud computing system 202 (or apart from the cloud computing system 202). In various implementations, the context query system 204 operates without or independently of the suggestion item system 210.

Turning to the next set of figures, as mentioned above, FIGS. 3, 4A-4B, and 5 provide additional details about generating an aggregated distribution embedding space with multiple embedding groups (or a combined set of embedding groups). To begin, FIG. 3 illustrates an example diagram for generating training data subsets from a training dataset for generating related disaggregated embedding groups according to some implementations. As shown, FIG. 3 includes a training dataset 310 in the form of a table with sample query entries.

As shown, the training dataset 310 includes sample queries 302 and corresponding sample suggestion item sets (e.g., a first sample suggestion item set 304a, a second sample suggestion item set 304b, and a third sample suggestion item set 304c). For example, sample queries 302 include sample user inputs that were used to create sample suggestion items. As also shown, each sample query is associated with multiple sample suggestion items (shown in different suggestion item sets for purposes of explanation), where the suggestion items include relevant and diverse queries a user can request as a follow-on query to the sample query. While three sample suggestion items per sample query are shown, the training dataset 310 can include any number of sample suggestion items for each sample query.

In various implementations, the training dataset 310 includes curated data generated from generative AI models or other sources. For instance, the suggestion item system 210 generates the training dataset 310 with a generative AI model that uses sequential decoding based on the sample queries 302. In this way, the suggestion item system 210 generates high-quality sample suggestion items that can be used as valuable training data.

In some implementations, the suggestion item system 210 prompts the generative AI model to generate high-quality sample suggestion items that are relevant, diverse, and based on user intents. In various instances, the suggestion item system 210 prompts the generative AI model to generate sample suggestion items based on other characteristics, such as providing user input as a phrase prefix and generating sample suggestion items that finish or complete the word or phrase of the user input. Indeed, the suggestion item system 210 can generate training datasets corresponding to suggested search queries, autocomplete suggestions, related search queries, or other types of suggestion items, as indicated above.

As provided above, the sequential decoding process can be computationally expensive and lengthy as suggestion items are decoded serially, with all previously generated suggestion items used as input in subsequent iterations. By doing so, the embedding distribution used to generate the next suggestion items becomes semantically different from the previous distribution used because the input includes prior suggestion items to avoid regeneration.

In various implementations, the suggestion item system 210 can perform the above process offline based on a set of sample queries, minimizing or eliminating latency issues. Furthermore, the suggestion item system 210 can execute the process during low-demand periods when computational resources are more available. In some implementations, the suggestion item system 210 obtains the training dataset 310 from a data store or another system that generates it.

In addition, the suggestion item system 210 can generate training data subsets from the training dataset 310. For example, the suggestion item system 210 pairs the sample queries 302 with each sample suggestion item set to generate a training data subset. As shown, the suggestion item system 210 partitions and pairs the sample queries 302 with the first sample suggestion item set 304a to generate a first training data subset 312a, the sample queries 302 with the second sample suggestion item set 304b to generate the second training data subset 312b, and the sample queries 302 with the third sample suggestion item set 304c to generate the third training data subset 312c. While the example includes three sample training data subsets, additional subsets may be generated based on the amount of available data in the training dataset 310.

As shown, each of the training data subsets corresponds to the sample queries 302 but includes distinct suggestion items. As noted above, the suggestion items for a sample query across the subsets are relevant to the sample query (e.g., sample user input) but diverse from each other, which results from the high-quality nature of the training dataset 310.

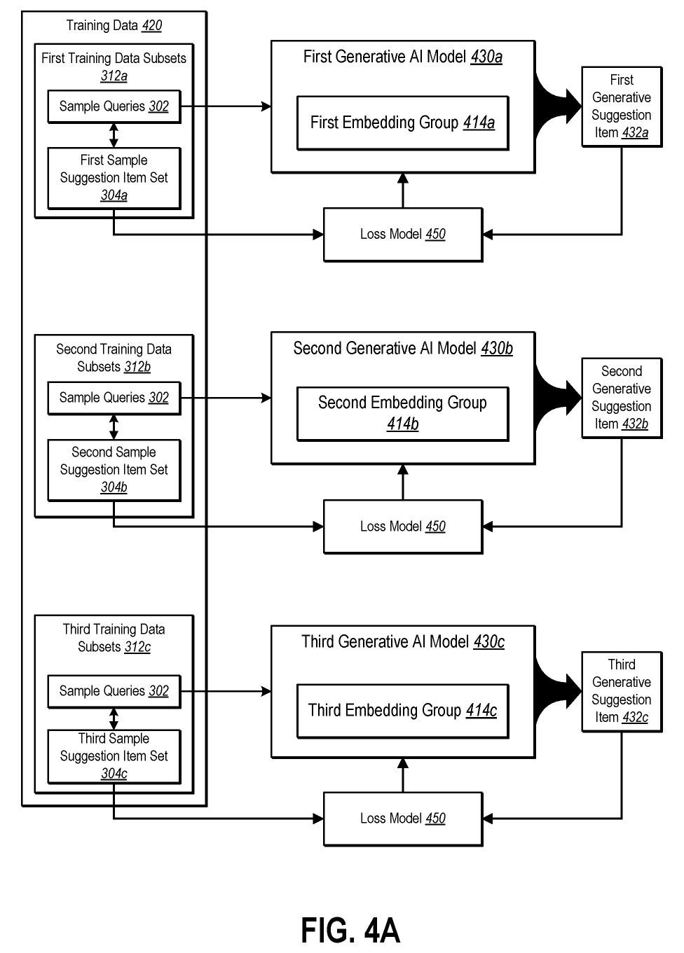

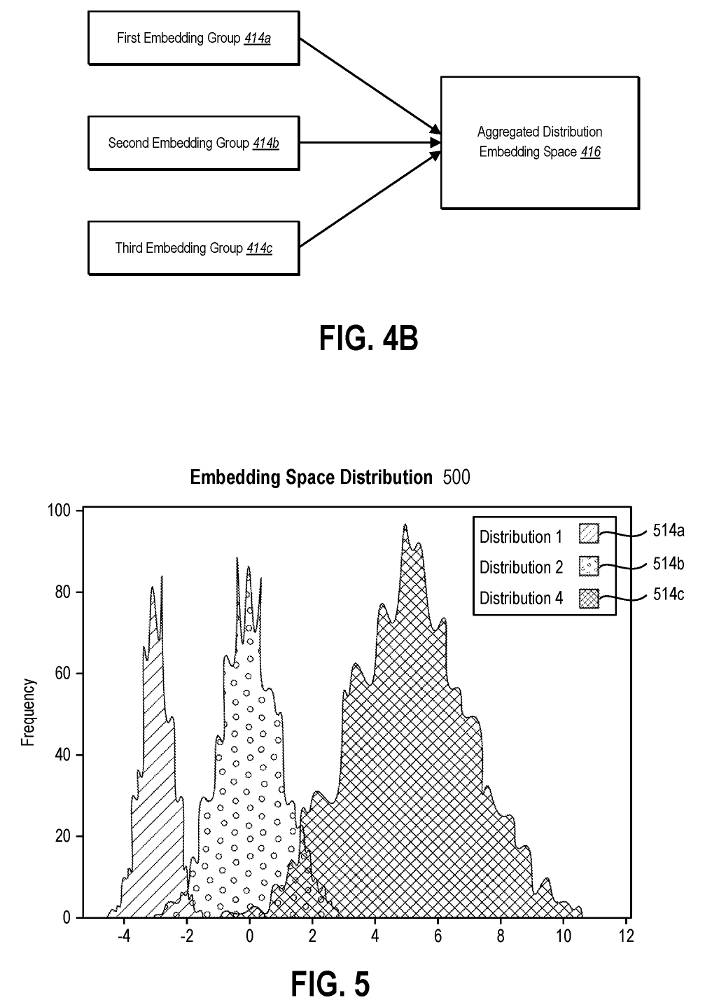

Based on the training data subsets, the suggestion item system 210 can generate an aggregated distribution embedding space with multiple embedding groups (or maintain a combined set of embedding groups), each having different embedding distributions. To illustrate, FIGS. 4A-4B show example diagrams for creating disaggregated embedding groups using generative AI models. In particular, FIG. 4A includes generating embedding groups, while FIG. 4B includes combining the embedding groups to form an aggregated distribution embedding space.

As shown, FIG. 4A includes training data 420 used to train generative AI models to generate suggestion items as well as create embedding groups. The training data 420 includes the first training data subset 312a, the second training data subset 312b, and the third training data subset 312c, with each of the training data subsets corresponding to a small generative AI model 430. The suggestion item system 210 can use generative AI models to generate any number of embedding groups.

In various implementations, the generative AI models (e.g., the first generative AI model 430a, the second generative AI model 430b, and the third generative AI model 430c) are small generative AI models, such as SLMs. In some instances, the generative AI models are different instances of the same small generative AI model. In some implementations, the models vary in type and/or version from one another. In one or more implementations, the generative AI models are LLMs or other types of large generative AI models.

To generate a first embedding group 414a, the embedding space creation manager 212 trains the first generative AI model 430a using the first training data subset 312a. For example, the suggestion item system 210 generates a prompt that includes a first sample query from the sample queries 302 directed to the first generative AI model 430a, which, in turn, generates a first generative suggestion item 432a.

Additionally, the suggestion item system 210 can use a loss model 450 to compare the first generative suggestion item 432a with a corresponding sample suggestion item (e.g., a ground truth sample suggestion) from the first generative AI model 430a. In some instances, the prompt includes the sample query, an embedding group identifier, and the corresponding sample suggestion item, which the model uses to learn an embedding space. Indeed, the suggestion item system 210 can include the embedding group identifier to label embeddings with the corresponding embedding group.

In various instances, the suggestion item system 210 can use end-to-end training to fine-tune the first generative AI model 430a to correctly generate suggestion items. By doing so, the suggestion item system 210 learns distinct disaggregated distributions as priors during training, which can then be seamlessly invoked during decoding at inference time to generate suggestion items. In some implementations, the embedding space creation manager 212 utilizes other techniques to train the first generative AI model 430a, resulting in the generation of the first embedding group 414a. Indeed, as the generated suggestion items become more accurate, the first embedding group 414a becomes more refined and reliable.

In one or more implementations, the suggestion item system 210 repeats this process with each training data subset and a corresponding generative AI model. Indeed, the suggestion item system 210 can generate a second embedding group 414b to create a second generative suggestion item 432b and a third embedding group 414c to create a third generative suggestion item 432c by training generative AI models with their corresponding or respective training data subsets (e.g., the second training data subset 312b and the third training data subset 312c) and extracting the embedding group created for each model instance.

Because the training data subsets have different suggestion items for the same set of sample queries, each model learns to semantically diverge its direction, resulting in different suggestion items given the same user input. The divergent direction for each model is embedded into the model’s embedding group. Thus, two embedding groups can be similar in that they both generate relevant suggestion items for the same user input, but the two embedding groups, when utilized in different generative AI models, yield semantically different results.

In various implementations, the generative AI models are trained concurrently. In some implementations, the suggestion item system 210 uses the same model instance to generate each of the embedding groups. In some implementations, the suggestion item system 210 utilizes a model to generate the embedding groups as a large generative AI model (e.g., an LLM) but then utilizes a small generative AI model (e.g., an SLM) at inference time to reduce computing processing.

FIG. 4B shows the generation of an aggregated distribution embedding space. In particular, FIG. 4B illustrates the suggestion item system 210 combining the separately generated embedding groups into the aggregated distribution embedding space 416. While the embedding groups may have overlapping embeddings in the aggregated distribution embedding space 416, each embedding group has its own distinct embedding distribution.

As mentioned above, while a single embedding space is shown for the aggregated distribution embedding space 416, in various instances, the aggregated distribution embedding space 116 represents a collection of embedding groups maintained together but not combined into a single embedding space. In these implementations, the generative AI models (or multiple model instances) can equally identify the correct embedding group based on an embedding group identifier, as described further below.

Furthermore, even within the aggregated distribution embedding space 416, each embedding group can be separately identified and referenced. For example, the suggestion item system 210 associates each embedding group with an identifier that allows the embedding group to be utilized while disregarding other embedding groups in the aggregated distribution embedding space 416.

As mentioned above, by using training data subsets rather than a combined training dataset, the suggestion item system 210 generates embedding groups that have different embedding distributions. In this way, the suggestion item system 210 learns multiple distributions that are associated with their corresponding identifier tokens, which can be leveraged during the inference phase to generate unique suggestion items with lower latency and lower computational cost.

To illustrate, FIG. 5 shows an example diagram chart that displays the distributions of multiple embedding groups generated from a common training dataset. In particular, FIG. 5 includes an embedding space distribution 500 of an aggregated distribution embedding space. For example, the embedding space distribution 500 features a first distribution 514a, a second distribution 514b, and a third distribution 514c. In many instances, the first distribution 514a corresponds to the first embedding group 414a generated based on the first training data subset 312a, the second distribution 514b corresponds to the second embedding group 414b, and the third distribution 514c corresponds to the third embedding group 414c generated based on the third training data subset 312c.

Notably, the embedding space distribution 500 is shown as an example of possible distributions based on a training data subset originating from the same training dataset. However, the shapes and sizes of the distributions may vary significantly (e.g., the normal distributions are shown for illustration purposes). In many instances, because the training dataset was generated at a high quality, in terms of relevant and diverse suggestion items, each of the embedding space distributions should inherit similarly high-quality results.

In some implementations, the distributions overlap, as shown. However, each distribution includes features and data statistics unique to that distribution. In various implementations, the distribution of a first embedding space does not overlap with the distribution of a second embedding space.

As mentioned above, FIG. 6 provides additional details regarding generating suggestion item prompts based on user input and generating suggestion item prompts using generative AI models through parallel decoding. In particular, FIG. 6 illustrates an example diagram for generating suggestion items based on user input with generative AI models using parallel decoding from different embedding groups according to some implementations.

As shown, FIG. 6 includes a series of acts 600 performed by, or in connection with, the suggestion item system 210. The series of acts 600 includes act 602 of receiving user input. For example, the user input is provided as a submitted search query or user prompt. In some implementations, the user input corresponds to a search query that has yet to be submitted (e.g., the user is typing in a search query, and each portion is received as user input).

Act 604 includes generating multiple suggestion item prompts. For instance, the suggestion item system 210 generates a set of suggestion item prompts that include the user input, instructions for a generative AI model, and a unique embedding group identifier (e.g., also referred to as an embedding group identifier). For example, multiple prompt instances include the user input (e.g., the query) and a unique embedding group identifier. In some instances, the prompt includes additional information, such as an output format or example suggestion items.

As shown in act 604, the suggestion item system 210 generates a first suggestion item prompt 606a with a first embedding group identifier 608a, a second suggestion item prompt 606b with a second embedding group identifier 608b, and a third suggestion item prompt 606c, with a third embedding group identifier 608c. In many instances, the suggestion item system 210 generates a series of identical prompts except for the embedding group identifier. The suggestion item system 210 can generate any number of suggestion item prompts to be provided concurrently or at the same time to a corresponding number of generative AI models. For example, the suggestion item system 210 provides the suggestion item prompts to the multiple instances of the generative AI models concurrently (e.g., at or near the same time). In this way, the small generative AI models can process their respective prompts in parallel to each decode a single suggestion item.

Act 610 includes generating multiple suggestion items. For example, the suggestion item system 210 provides each generated suggestion item prompt to a small generative AI model 430. In various implementations, the small generative AI model 430 is a small language model (SLM), which generates suggestion items with fewer computational resources than a larger generative AI model. In some implementations, the small generative AI models are different instances of the same generative AI model. In various implementations, the small generative AI models are different model types or versions.

As shown, the suggestion item system 210 provides the first suggestion item prompt 606a with the first embedding group identifier 608a to a small generative AI model 430, which generates a first generative suggestion item 612a. Based on the first embedding group identifier 608a included in the suggestion item prompt, the small generative AI model 430 accesses and generates the first generative suggestion item 612a based on the first embedding group 414a. Indeed, the small generative AI model 430 utilizes the first embedding group 414a to influence its analysis and generate a suggestion item that aligns with the context provided in the first embedding group 414a.

Similarly, in providing the second suggestion item prompt 606b with the second embedding group identifier 608b to the second instance of the small generative AI model 430, the model utilizes the second embedding group 414b, as instructed, to generate the second generative suggestion item 612b The third instance of the small generative AI model 430 also receives the third suggestion item prompt 606c with the third embedding group identifier 608c to generate the third generative suggestion item 612c in light of the context included in the third embedding group 414c. In some implementations, the different model instances are implemented on different GPU units, computational units, and/or devices.

Moreover, because each of the small generative AI models uses different embedding groups, which have different embedding distributions, they generate related results that are semantically different and distinct from each other. Stated differently, by ensuring that each distribution remains distinct during sampling (e.g., training), the suggestion item system 210 provides diverse suggestions that are sampled from learned disaggregated distributions.

The small generative AI models may use the same or different decoding algorithms to generate their respective suggestion items. However, in many implementations, the small generative AI models perform parallel decoding to significantly reduce latency. Further, as mentioned above, when performing parallel processing, a single resource call can be made that covers all of the multiple generative AI models (e.g., batch processing calls). For example, a single call to obtain the aggregated distribution embedding space can be made, and upon retrieving the embedding space, each model utilizes its own embedding group identifier to locate the relevant embedding group to solve the user query. Indeed, in various implementations, the generative AI models access the same shared memory resource, from a shared resource call, during processing

Act 612 includes generating a list of suggestion items. For example, the suggestion item system 210 receives each of the suggestion items from the small generative AI models at or around the same time. Indeed, because each model performs a single-shot decoding using the same user input, each of the models can provide their generated suggestion item around the same time.

In particular, the suggestion item system 210 can group the suggestion items into a suggestion list (e.g., a suggestion items list). As shown, act 612 includes grouping the first generative suggestion item 612a, the second generative suggestion item 612b, and the third generative suggestion item 612c into the list of suggestion items 614.

Furthermore, act 616 includes providing the list of suggestion items in response to the user input. For example, the suggestion item system 210 can send the list of suggestion items 614 to the client device that requested the search query and/or provided the user input. In some implementations, the suggestion item system 210 provides the suggestion items not as a suggestion list but as separate items.

As mentioned above, FIGS. 7A-7B provide examples of providing suggestion items in connection with search queries. For instance, FIGS. 7A-7B illustrate example graphical user interfaces that show suggestion items provided in response to a user input according to some implementations.

As shown, FIGS. 7A-7B include a client device 700 that includes a display of a graphical user interface 702. The graphical user interface 702 includes a client application 710, such as a web browser application. The client application 710 may provide access to a search utility for obtaining search queries. For instance, the search utility receives user input corresponding to a search query for search results and, in response, provides the user input to the suggestion item system 210, which generates suggestion items (e.g., autocomplete phrases for searches that expand upon user input, related search queries, or follow-on search queries) to provide to the client application 710. Indeed, the client application 710 may allow a user to interact with the search query system and/or the suggestion item system to receive suggestion items.

Turning to FIG. 7A, this figure corresponds to providing suggestion items within a generative search document. For example, the client application 710 shows a comprehensive generative search document 712 (or at least a portion of the generative document) provided in response to a search query. As mentioned, the suggestion item system 210 may receive and use the search query 714 as user input to quickly generate multiple suggestion items using parallel decoding, where the suggestion items are generated before the comprehensive generative search document 712 can be completely generated.

As shown, the comprehensive generative search document 712 includes suggestion items in the form of follow-on search queries 716 at the end of the first curated section. In some implementations, the suggestion item system 210 generates suggestion items for multiple sections or portions of the search results. Furthermore, upon selecting a follow-on search query, the search query system uses the selected suggestion item to perform the follow-on search.

FIG. 7B shows an example of providing suggestion items in the form of search autocomplete suggestions. As shown, the client application 710 on the client device 700 displays a web search with an input field 720 where a user can provide text input or another type of input (e.g., audio or an image) for a search query. As shown, the input field 720 includes user input 722 (e.g., a prefix). Additionally, the client application 710 includes an autosuggest pane that displays autosuggest queries 730 (e.g., suggestion items) corresponding to the user input 722. Upon detecting the selection of one of the autosuggest queries 730, a search query system (e.g., a content query system) triggers a search user based on the selected autosuggest query.

While illustrative examples of providing suggestion items with generative search documents and autocomplete queries are shown, the suggestion item system 210 can provide suggestion items in several other use cases, such as chat-based generative AI models. As noted above, suggestion items can include autocompleting phrases, follow-on queries, related questions, location-based suggestion queries, “people also ask” queries, recommendation questions, creative prompts, and other query-related suggestions curated by generative AI models.

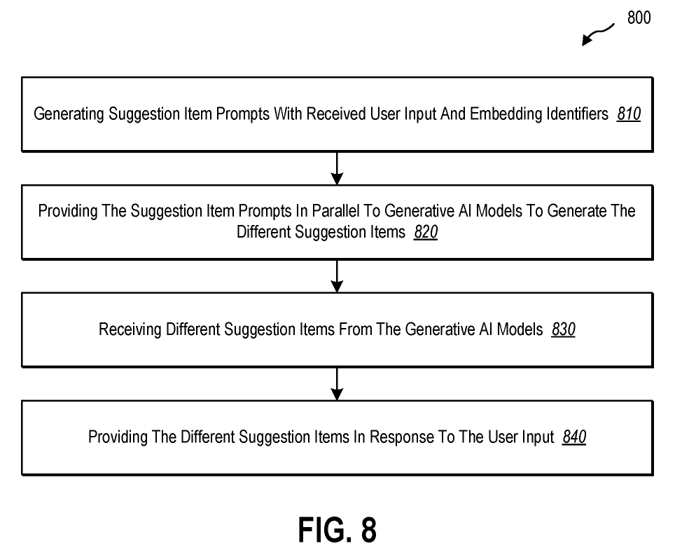

Turning now to FIG. 8, this figure illustrates an example flowchart that includes a series of acts for utilizing the suggestion item system 210. In particular, FIG. 8 illustrates an example series of acts of a computer-implemented method for generating suggestion items using one or more AI models according to some implementations.

The acts in FIG. 8 can be performed as part of a method (e.g., a computer-implemented method). Alternatively, a computer-readable medium can include instructions that, when executed by a processing system with a processor, cause a computing device to perform the acts in FIG. 8. In some implementations, a system (e.g., a processing system comprising a processor) can perform the acts in FIG. 8. For example, the system includes a processing system and a computer memory with instructions that, when executed by the processing system, cause the system to perform various actions or steps.

As shown, the series of acts 800 includes act 810 of generating suggestion item prompts with received user input and embedding group identifiers. For instance, in example implementations, act 810 involves generating multiple suggestion item prompts that include the user input and multiple embedding group identifiers based on receiving user input associated with a search query. In various implementations, act 810 includes generating, based on receiving user input associated with a search query, a first suggestion item prompt that includes the user input and a first embedding group identifier, and a second suggestion item prompt that includes the user input and a second embedding group identifier. In various implementations, the first embedding group identifier differs from the second embedding group identifier. In some implementations, each of the multiple embedding group identifiers or tokens differs. In one or more implementations, the user input includes a user prompt to a chat-based generative AI model.

As further shown, the series of acts 800 includes act 820 of providing the suggestion item prompts in parallel to generative AI models to generate the different suggestion items. For instance, in example implementations, act 820 involves providing the multiple suggestion item prompts in parallel to a corresponding number of generative AI models to generate multiple suggestion items corresponding to the user input. In one or more implementations, act 820 includes providing the first suggestion item prompt to a first generative AI model to generate a first suggestion item corresponding to the user input and providing the second suggestion item prompt to a second generative AI model to generate a second suggestion item corresponding to the user input, wherein the first suggestion item prompt and the second suggestion item prompt are provided concurrently.

In some instances, act 820 includes providing the first suggestion item prompt to a first generative AI model to generate a first suggestion item corresponding to the user input based on the first embedding group. In various implementations, act 820 includes providing the second suggestion item prompt to a second generative AI model to generate a second suggestion item corresponding to the user input based on the second embedding group, wherein the first suggestion item prompt and the second suggestion item prompt are provided concurrently.

In some implementations, the first generative AI model and the second generative AI model are different instances of the same generative AI model that includes an aggregated distribution embedding space (or a combined set of embedding groups) with a first embedding group and a second embedding group. In various implementations, the first embedding group identifier informs or directs the first generative AI model to generate the first suggestion item from embeddings within the first embedding group, and the second embedding group identifier informs or directs the second generative AI model to generate the second suggestion item from embeddings within the second embedding group.

In one or more implementations, the first embedding group forms a first embedding space distribution and the second embedding group forms a second embedding space distribution, and the first embedding space distribution does not overlap with the second embedding space distribution. In some instances, the first generative AI model and the second generative AI model are small language models that operate in parallel, each using a single-shot operation with autoregressive decoding to respectively generate and return the first suggestion item and the second suggestion item. In various implementations, the first generative AI model and the second generative AI model generate the first suggestion item and the second suggestion item in parallel, and generating the first suggestion item and the second suggestion item in parallel includes the first generative AI model and the second generative AI model accessing shared memory resource during processing.

As further shown, the series of acts 800 includes act 830 of receiving different suggestion items from the generative AI models. For instance, in example implementations, act 830 involves receiving the multiple suggestion items from the generative AI models, wherein the multiple suggestion items generated based on the user input differ. In various implementations, act 830 includes receiving the first suggestion item and the second suggestion item, wherein the first suggestion item generated based on the user input differs from the second suggestion item generated based on the user input. In some instances, the first generative AI model generates a first set of outputs based on the first embedding group when provided with a set of inputs, the second generative AI model generates a second set of outputs based on the second embedding group when provided with the set of inputs, and the first set of outputs is semantically different from the second set of outputs.

As shown further, the series of acts 800 includes act 840 of providing the different suggestion items in response to the user input. For instance, in example implementations, act 840 involves providing the multiple suggestion items in response to receiving the user input. In one or more implementations, act 840 includes providing the first suggestion item and the second suggestion item in response to receiving the user input. In some implementations, act 840 includes providing the multiple suggestion items in response to receiving the user input.

In some implementations, act 840 includes generating a list of suggestion items that includes the first suggestion item prompt and the second suggestion item prompt, where the first suggestion item prompt and the second suggestion item prompt are provided within a list of suggestions. In various implementations, the first suggestion item and the second suggestion item include follow-on user prompts corresponding to the user prompt to provide to the chat-based generative AI model. In some cases, the user input includes user input in a web search text field, and the first suggestion item and the second suggestion item include suggested search query phrases expanding upon the user input for a web search query.

In various implementations, the series of acts 800 can include various additional acts. For example, the series of acts 800 includes generating an aggregated distribution embedding space (or combined set of embedding groups) with a first embedding group and a second embedding group based on partitioning a training dataset into training data subsets that pair a sample query with a different sample suggestion item corresponding to the sample query.

In one or more implementations, the series of acts 800 includes identifying a training dataset that includes a table of sample queries, wherein each of the sample queries corresponds to a first sample suggestion from a first set of suggestion items and a second sample suggestion from a second set of suggestion items, wherein the first sample suggestion differs from the second sample suggestion for each of the sample queries. In some instances, the series of acts 800 includes generating a first training data subset that includes each of the sample queries and their corresponding first sample suggestion items from the first set of suggestion items, and generating a second training data subset that includes each of the sample queries and their corresponding second sample suggestion items from the second set of suggestion items.

In some implementations, the series of acts 800 includes generating a first embedding group using a set of prompts generated from the sample queries to identify corresponding first sample suggestion items from the first training data subset, and generating a second embedding group using the set of prompts generated from the sample queries to identify corresponding second sample suggestion items from the second training data subset. In some implementations, the series of acts 800 includes combining the first embedding group and the second embedding group into an aggregated distribution embedding space (or a combined set of embedding groups), and providing the aggregated distribution embedding space (or the combined set of embedding groups)to the first generative AI model and the second generative AI model, wherein the first generative AI model selects the first embedding group when provided with a prompt that indicates the first embedding group identifier.

In one or more implementations, the series of acts 800 includes generating a first aggregated distribution embedding space (or a first combined set of embedding groups) with a first set of embedding groups based on a first training dataset corresponding to generating a first set of suggestion items that include follow-on suggestion user prompts, and generating a second aggregated distribution embedding space (or a second combined set of embedding groups) with a second set of embedding groups based on a second training dataset corresponding to generating a second set of suggestion items that include autocomplete suggestion items that expand upon the user input.

In various implementations, the series of acts 800 includes identifying a training dataset that includes a table of sample query entries, wherein each sample query entry includes a sample query and a set of corresponding sample suggestion items, wherein sample suggestion items in a sample query entry differ from each other. In one or more implementations, the series of acts 800 includes generating multiple training data subsets that each include each sample query and one sample suggestion item from the set of corresponding sample suggestion items associated with the sample query, wherein the multiple training data subsets include different corresponding sample suggestion items for the same sample query. In one or more implementations, the series of acts 800 includes generating multiple embedding groups using a set of prompts generated from sample queries and the multiple training data subsets, combining the multiple embedding groups into an aggregated distribution embedding space (or a combined set of embedding groups), and providing the aggregated distribution embedding space (or the combined set of embedding groups) to the generative AI models, wherein the generative AI models select an embedding group based on a prompt indicating an embedding group identifier from the multiple embedding group identifiers.

FIG. 9 illustrates certain components that may be included within a computer system 900. The computer system 900 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 900 represents one or more of the client devices, server devices, or other computing devices described above. For example, the computer system 900 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 900 includes a processing system including a processor 901. The processor 901 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 901 may be referred to as a central processing unit (CPU) and may cause computer-implemented instructions to be performed. Although the processor 901 shown is just a single processor in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 905 and the data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during the execution of the instructions 905 by the processor 901.

A computer system 900 may also include one or more communication interface(s) 909 for communicating with other electronic devices. The one or more communication interface(s) 909 may be based on wired communication technology, wireless communication technology, or both. Some examples of the one or more communication interface(s) 909 include a Universal Serial Bus (USB), an Ethernet adapter, a wireless adapter that operates according to an Institute of Electrical and Electronics Engineers (IEEE) 902.11 wireless communication protocol, a Bluetooth® wireless communication adapter, and an infrared (IR) communication port.

A computer system 900 may also include one or more input device(s) 911 and one or more output device(s) 913. Some examples of the one or more input device(s) 911 include a keyboard, mouse, microphone, remote control device, button, joystick, trackball, touchpad, and light pen. Some examples of the one or more output device(s) 913 include a speaker and a printer. A specific type of output device that is typically included in a computer system 900 is a display device 915. The display device 915 used with implementations disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For clarity, the various buses are illustrated in FIG. 9 as a bus system 919.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating suggestion items using one or more artificial intelligence (AI) models, comprising:
based on receiving user input associated with a search query:
generating a first suggestion item prompt that includes the user input and a first embedding group identifier; and
generating a second suggestion item prompt that includes the user input and a second embedding group identifier, wherein the first embedding group identifier differs from the second embedding group identifier;
providing the first suggestion item prompt to a first generative AI model to generate a first suggestion item corresponding to the user input;
providing the second suggestion item prompt to a second generative AI model to generate a second suggestion item corresponding to the user input, wherein the first suggestion item prompt and the second suggestion item prompt are provided concurrently;
receiving the first suggestion item and the second suggestion item, wherein the first suggestion item generated based on the user input differs from the second suggestion item generated based on the user input; and
providing the first suggestion item and the second suggestion item in response to receiving the user input.

2. The computer-implemented method of claim 1, wherein:
the first generative AI model and the second generative AI model are different instances of a same generative AI model that includes a first embedding group and a second embedding group;
the first embedding group identifier informs the first generative AI model to generate the first suggestion item from embeddings within the first embedding group; and
the second embedding group identifier informs the second generative AI model to generate the second suggestion item from embeddings within the second embedding group.

3. The computer-implemented method of claim 2, wherein:
the first embedding group forms a first embedding space distribution;
the second embedding group forms a second embedding space distribution; and
the first embedding space distribution does not overlap with the second embedding space distribution.

4. The computer-implemented method of claim 2, wherein:
the first generative AI model generates a first set of outputs based on the first embedding group when provided with a set of inputs;
the second generative AI model generates a second set of outputs based on the second embedding group when provided with the set of inputs; and
the first set of outputs is semantically different from the second set of outputs.

5. The computer-implemented method of claim 1, further comprising:
generating a list of suggestion items that includes the first suggestion item prompt and the second suggestion item prompt, and
wherein the first suggestion item prompt and the second suggestion item prompt are provided within a list of suggestions.

6. The computer-implemented method of claim 1, wherein the user input includes a user prompt to a chat-based generative AI model.

7. The computer-implemented method of claim 6, wherein the first suggestion item and the second suggestion item include follow-on user prompts corresponding to the user prompt to provide to the chat-based generative AI model.

8. The computer-implemented method of claim 1, further comprising identifying a training dataset that includes a table of sample queries, wherein each of the sample queries corresponds to a first sample suggestion from a first set of suggestion items and a second sample suggestion from a second set of suggestion items, wherein the first sample suggestion differs from the second sample suggestion for each of the sample queries.

9. The computer-implemented method of claim 8, further comprising:
generating a first training data subset that includes each of the sample queries and their corresponding first sample suggestion items from the first set of suggestion items; and
generating a second training data subset that includes each of the sample queries and their corresponding second sample suggestion items from the second set of suggestion items.

10. The computer-implemented method of claim 9, further comprising:
generating a first embedding group using a set of prompts generated from the sample queries to identify corresponding first sample suggestion items from the first training data subset; and
generating a second embedding group using the set of prompts generated from the sample queries to identify corresponding second sample suggestion items from the second training data subset.

11. The computer-implemented method of claim 10, further comprising:
combining the first embedding group and the second embedding group into an aggregated distribution embedding space; and
providing the aggregated distribution embedding space to the first generative AI model and the second generative AI model, wherein the first generative AI model selects the first embedding group when provided with a prompt that indicates the first embedding group identifier.

12. The computer-implemented method of claim 1, further comprising:
generating a first aggregated distribution embedding space with a first set of embedding groups based on a first training dataset corresponding to generating a first set of suggestion items that include follow-on suggestion user prompts; and
generating a second aggregated distribution embedding space with a second set of embedding groups based on a second training dataset corresponding to generating a second set of suggestion items that include autocomplete suggestion items.

13. The computer-implemented method of claim 1, wherein the first generative AI model and the second generative AI model are small language models that operate in parallel, each using a single-shot operation with autoregressive decoding to respectively generate and return the first suggestion item and the second suggestion item.

14. The computer-implemented method of claim 1, wherein:
the user input includes user input in a web search text field; and
the first suggestion item and the second suggestion item include suggested search query phrases expanding upon the user input for a web search query.

15. A computer-implemented method for generating suggestion items using one or more artificial intelligence (AI) models, comprising:
based on receiving user input associated with a search query, generating multiple suggestion item prompts that include the user input and multiple embedding group identifiers, wherein each of the multiple embedding group identifiers differ;
providing the multiple suggestion item prompts in parallel to a corresponding number of generative AI models to generate multiple suggestion items corresponding to the user input;
receiving the multiple suggestion items from the generative AI models, wherein the multiple suggestion items generated based on the user input differ; and
providing the multiple suggestion items in response to receiving the user input.

16. The computer-implemented method of claim 15, further comprising identifying a training dataset that includes a table of sample query entries, wherein each sample query entry includes a sample query and a set of corresponding sample suggestion items, wherein sample suggestion items in a sample query entry differ from each other.

17. The computer-implemented method of claim 16, further comprising:
generating multiple training data subsets that each include each sample query and one sample suggestion item from the set of corresponding sample suggestion items associated with the sample query, wherein the multiple training data subsets include different corresponding sample suggestion items for a same sample query.

18. The computer-implemented method of claim 17, further comprising:
generating multiple embedding groups using a set of prompts generated from sample queries and the multiple training data subsets; and
providing the multiple embedding groups to the generative AI models, wherein the generative AI models select an embedding group based on a prompt indicating an embedding group identifier from the multiple embedding group identifiers.

19. A system comprising:
a processing system; and
a computer memory comprising instructions that, when executed by the processing system, cause the system to perform operations of:
generating a combined set of embedding groups with a first embedding group and a second embedding group based on partitioning a training dataset into training data subsets that pair a sample query with a different sample suggestion item corresponding to the sample query;
based on receiving user input associated with a search query:
generating a first suggestion item prompt that includes the user input and a first embedding group identifier; and
generating a second suggestion item prompt that includes the user input and a second embedding group identifier, wherein the first embedding group identifier differs from the second embedding group identifier;
providing the first suggestion item prompt to a first generative AI model to generate a first suggestion item corresponding to the user input based on the first embedding group;
providing the second suggestion item prompt to a second generative AI model to generate a second suggestion item corresponding to the user input based on the second embedding group, wherein the first suggestion item prompt and the second suggestion item prompt are provided concurrently;
receiving the first suggestion item and the second suggestion item, wherein the first suggestion item generated based on the user input differs from the second suggestion item generated based on the user input; and
providing the first suggestion item and the second suggestion item in response to receiving the user input.

20. The system of claim 19, wherein:
the first generative AI model and the second generative AI model generate the first suggestion item and the second suggestion item in parallel; and
generating the first suggestion item and the second suggestion item in parallel includes the first generative AI model and the second generative AI model accessing shared memory resource during processing.
